(19) United States
(12) Patent Application Publication
(10) Pub. No.: US 2016/0320354 A1
(43) Pub. Date: Nov. 3, 2016

(54) DEVICE FOR EXTRACTING A VOLATILE COMPONENT

(71) Applicant: CTC Analytics AG, Zwingen (CH)

(72) Inventors: Stefan Anton CRETNIK, Grellingen (CH); Kai Heinrich SCHUELER, Hoffeld (CH); Melchior ZUMBACH, Lenzburg (CH)

(73) Assignee: CTC Analytics AG, Zwingen (CH)

(21) Appl. No.: 15/141,984

(22) Filed: Apr. 29, 2016

(30) Foreign Application Priority Data
May 1, 2015 (EP) 15001306.8

(51) Int. Cl. G01N 30/04

(52) U.S. Cl. CPC G01N 30/04

(57) ABSTRACT

The present application relates to a device for extracting volatile components from a sample. The device comprises a sample vessel for receiving the sample with a supply line and with a discharge line, wherein the sample vessel is closed in a gas-tight manner, and also a gas reservoir, which is connected to the supply line. Moreover, the device has a trap element, which is fluidically connected to the discharge line and which has at least one absorber material. The trap element is connected releasably to the discharge line, wherein the trap element has a gas outlet such that, when the trap element is connected to the discharge line, a gas from the gas reservoir can flow through said trap element.

### TECHNICAL FIELD

The invention relates to a device for extracting a volatile component from a sample, in particular from a liquid sample.

### PRIOR ART

Various devices are known in the prior art for extracting volatile components, for example volatile organic compounds (VOC), from a sample. It is desirable in particular to transfer volatile components from a sample to the gas phase and then collect the latter, for example in a column with suitable absorber material.

Particularly in the field of environmental analysis, extraction devices of this kind are used to detect contaminants in water samples or soil samples. The extracted volatile components are collected in a trap column and then volatilized from this by action of heat, wherein the volatile components are transferred to an analysis apparatus, in particular a gas chromatograph, where they can be separated, identified and also quantified.

The so-called purge and trap method has in particular become established in this field. In this method, an inert gas is passed through a sample. Volatile components transfer from the sample into the gas phase. These components are then collected on a suitable absorber material or in a cold trap. In the final expulsion step, the trap is heated such that the volatile components can be transferred to a gas chromatograph.

EP 0 590 932 A1 (Peters A.) discloses a trap system with a trap column, in particular for chromatography. The system comprises, among other things, a vacuum pump, which is connected via a valve to the output opening of the trap column and to the input opening of a separating column, and also a source of a carrier gas. When the vacuum pump is switched on, an analyte is sucked by the resulting underpressure into the trap column, which is designed as a cold trap. At the same time, the separating column is backflushed. Then, by separating the vacuum pump from the system and allowing the carrier gas to flow in through the input opening of the trap column and heating the latter, the molecules collected in the cold trap can be flushed into the separating column and then fed to a GC. The inner wall of the trap column can be coated with a porous polymer.

U.S. Pat. No. 6,395,560 B1 (Merkelov M.) describes a headspace device that can be used in a purge and trap method. The analyte withdrawn from the headspace by the carrier gas can be concentrated in a trap. Carrier gas and analyte that are not held back in the trap can either be released into the atmosphere or collected, for example in a helium trap.

U.S. Pat. No. 6,365,107 B1 relates to a headspace device in which a disturbance of the thermodynamic equilibrium in the sample vessel is not interrupted by the withdrawal of analyte. For this purpose, the device has two piston syringes, wherein a defined volume of analyte is withdrawn via a first piston syringe and, at the same time, the same volume of an inert gas is injected into the sample vessel by means of the second piston syringe.

A disadvantage of the known devices is that, after the desorption of the volatile components concentrated in the trap, said components are transferred through a transfer line to an analysis apparatus. On account of the length of the transfer line, the volatile components are taken up again in a gas volume, whereupon the focusing of the concentrated analytes decreases, which can lead to signal propagation, or even to signal loss, in a spectrographic analysis. The use of a transfer line necessitates complex maintenance measures, for example in the event of leaks or contamination, and greater outlay in terms of instrumentation, for example the provision of a separate heater for the transfer line, special connections to the inlet of an analysis system, spatial proximity to an analysis system, etc.

### DISCLOSURE OF THE INVENTION

The object of the invention is to make available a device for extracting volatile components from a sample, which device pertains to the technical field mentioned at the outset and avoids the stated disadvantages of the prior art.

The object is achieved by the features of Claim 1. According to the invention, the device comprises a sample vessel for receiving the sample, wherein the sample vessel is closed in a gas-tight manner. The sample vessel has a supply line and a discharge line. Moreover, the device is assigned a gas reservoir, which is connected to the supply line. A trap element, which is fluidically connected to the discharge line and which has at least one absorber material, is connected releasably to the discharge line. The trap element has a gas outlet such that, when the trap element is connected to the discharge line, a gas from the gas reservoir can flow through said trap element.

By virtue of the fact that the trap element is fluidically connected to the discharge line in a releasable manner, the trap element can easily be released from the device and transferred to an analysis apparatus. In this way, the device for extraction can be spatially separate from the analysis apparatus. Moreover, no transfer line is needed, since the trap element can be connected directly to an injection opening of an analysis apparatus.

The trap element is preferably fluidically connected to the discharge line via a releasable connection that is easy to operate. Generally, in the present application, a “releasable connection” is understood as a connection between two fluid lines that is preferably produced and undone by hand, without using tools, or automatically.

The trap element preferably has at least one valve or at least one closure, with which the absorber material located in an interior of the trap element can be separated off from the surrounding atmosphere in a gas-tight manner.

The sample is preferably present as a solid or as a liquid. A gas space, the so-called headspace, remains above the sample in the sample vessel. After the sample is introduced into the sample vessel, which is preferably made of glass or of a polymer resistant to chemicals, the sample vessel is closed in a gas-tight manner, for example with a stopper, cover, septum or the like.

The supply line and the discharge line can be formed on the sample vessel itself, for example in the form of connector stubs that can be connected to the fluid lines. Alternatively, the closure piece of the sample vessel can also have the supply line and the discharge line or can be connected to these. Moreover, it is also conceivable that the supply line and the discharge line are plugged into the sample vessel after the latter has been closed, for example through suitable openings. As a person skilled in the art will know, the attachment of the supply line and discharge line to the sample vessel must be made gas-tight with respect to the atmosphere.

The gas supply is preferably designed as a valve which is connected to at least one gas source, for example a gas canister containing an inert carrier gas, for example helium, nitrogen, carbon dioxide or argon. A carrier gas can be introduced through the supply line into the sample vessel via the gas reservoir.

The discharge line is preferably connected to the trap element via at least one fluid line. The at least one fluid line can be present in any desired form, for example as a hose, capillary, glass tube, etc.

The trap element has a suitable absorber material, for example a porous polymer based on 2,6-diphenyl-p-phenylene oxide, which is sold under the trade name Tenax® by Buchem BV, or activated charcoal. Depending on the nature of the substances to be extracted, a suitable absorber material can be used for the trap. Alternatively, a cold trap can also be used as the trap, if appropriate in combination with an absorber material.

If a carrier gas is conveyed from the gas reservoir to the sample vessel through the supply line, volatile components are expelled from the sample. In the case of liquid samples, the supply line is particularly preferably arranged in the sample vessel in such a way that the gas is introduced into the liquid in a lower area of the sample vessel and then bubbles through this. By way of the discharge line, the gas and the expelled volatile components reach the trap element, where the volatile components are held back by the absorber material.

The trap element is designed in such a way that the gas is conveyed through the absorber material before it reaches the gas outlet. The gas outlet preferably has a closable valve.

The trap element is preferably designed as a column, which has an inlet opening and an outlet opening. The releasable connection is arranged at the inlet opening, and the gas outlet is arranged at the outlet opening of the column.

The trap element is preferably connected to the discharge line via a quick-action coupling.

A “quick-action coupling”, in the sense of the present application, is understood to mean coupling systems that allow the connection to be produced and released without tools, and in particular using one hand. The quick-action coupling used is preferably a bayonet catch, a clamping ring or a pressure coupling. Alternatively, the releasable connection can also be provided by a screw coupling, a crimped screw union, a Luer coupling or the like.

The trap element preferably has a cannula, which is connected releasably to the discharge line via an access opening, wherein the cannula is in particular plugged into the access opening.

It is in this way possible to obtain, between the trap element and the discharge line, a releasable fluidic connection which can be easily integrated in automated systems, particularly with customary laboratory robots. The access opening is configured in particular in such a way that it is closed in a gas-tight manner when no cannula is plugged in. For example, the access opening can have a septum into which the cannula can be pushed.

Preferably, the gas outlet is fluidically connected to the supply line in a releasable manner. A closed gas circuit can thus be obtained in which the gas consumption can be greatly reduced. Moreover, contamination of the environment by components not held back in the trap element is avoided. In the case of a closed gas circuit, there is additionally the advantage of there being no limitation by a breakthrough capacity, i.e. an infinite volume of gas can in theory be conveyed through the trap element, without the volatile substances to be extracted escaping from the trap element and being lost.

In this configuration of the device, a pump is preferably arranged between discharge line and trap element in order to ensure circulation of the gas.

The releasable connection between the trap element and the inlet is preferably produced by a quick-action coupling. In this way, the connection of the trap element to the supply line and also to the discharge line can be released and produced quickly.

At least one fluid line connecting the gas outlet to the supply line is preferably arranged between the gas outlet and the supply line.

The trap element is preferably designed as a syringe, wherein the absorber material is arranged in a barrel of the syringe.

Such a design of the trap element permits very simple transfer of the trap element from the device to an analysis apparatus. Moreover, in the desorption of volatile substances held back in the trap element, the volume injected into the analysis apparatus can be controlled very precisely, for example via the total volume of the syringe used, or via a piston arranged movably in the syringe.

Such trap elements are known in the prior art and are marketed by the applicant CTC Analytics under the name ITEX.

The device preferably has a handling element with which the trap element is movable from the discharge line to an injection port of an analysis apparatus, in particular a gas chromatograph.

In an embodiment of this kind, the device preferably has a device permitting automatic release of the connection between the discharge line, and alternately the supply line, and the trap element. This permits the greatest possible degree of automation of the device.

A water trap is preferably arranged between discharge line and trap element. By means of the water trap, it is possible to remove from the gas any water that could otherwise cause interference in a subsequent analysis of the volatile components held back in the trap element in a gas chromatograph. Molecular sieves in particular are used as water trap. The water trap is in this case preferably arranged in such a way that the entirety of the gas flows through the water trap before flowing into the trap element.

The trap element is preferably arranged releasably in a holder, wherein the holder has a heating and/or cooling device.

A heating device permits rapid and virtually complete desorption of volatile components held back in the trap element. By way of a cooling device, the temperature of the trap element can be reduced in the sense of a cold trap, in order to permit virtually complete retention of the volatile components in the trap element.

The present invention further relates to a method for extracting volatile components from a sample, in particular using a device according to the present application. In a first step, a sample is arranged in a sample vessel with a supply line and a discharge line, wherein the sample vessel is then closed in a gas-tight manner. In a second step, gas is introduced through the supply line into the sample vessel, wherein the gas is conveyed through the discharge line into a trap element, connected fluidically and releasably to said discharge line, and flows through said trap element. The gas then escapes from the trap element through a gas outlet. After a certain time, the introduction of the gas is interrupted. The trap element is then released from the discharge line and transferred to an analysis apparatus.

Further advantageous embodiments and combinations of features of the invention will become clear from the following detailed description and from all of the patent claims.

### BRIEF DESCRIPTION OF THE DRAWINGS

In the drawings used to explain the illustrative embodiment:

FIG. 1 shows a schematic view of a first embodiment of a device according to the invention;

FIG. 2 shows a schematic view of a second embodiment, in which the gas outlet of the trap element is connected to the supply line;

FIG. 3 shows a schematic view of a third embodiment, in which the trap element is designed as a syringe.

Identical parts in the figures are in principle provided with identical reference signs.

### WAYS OF IMPLEMENTING THE INVENTION

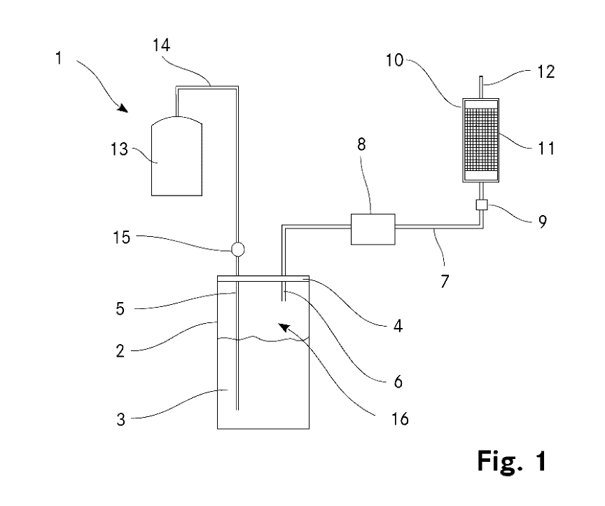

FIG. 1 shows a schematic view of a first embodiment of a device 1 according to the invention for extracting volatile components from a sample, which is shown as sample liquid 3. The sample liquid 3 is present in a sample vessel 2 which is closed in a gas-tight manner by a closure 4, for example a cover. A supply line 5 and a discharge line 6 protrude through the closure 4 into the sample vessel 2. The supply line 5 is arranged in the sample vessel 2 in such a way that it protrudes into the sample liquid 3. Moreover, the supply line 5 is connected via a gas valve 15 and a gas line 14 to a gas reservoir, which is shown as a gas canister 13. When the gas valve 15 is opened, gas from the gas canister 13 can be introduced into the sample vessel 2. In the illustrative embodiment shown, the gas will bubble through the sample liquid 3 and then emerge in a gas space 16, the so-called headspace, left free above the sample liquid 3.

The discharge line 6 is arranged in the sample vessel 2 in such a way that it protrudes into this gas space 16, wherein the gas introduced through the supply line 5 flows out of the sample vessel 2 through the discharge line 6. By the gas flowing out of the gas space 16, no equilibrium can be obtained between the volatile components located in the sample liquid 3 and in the gas space 16, with the result that said components are gradually driven out of the sample liquid 3 into the gas space 16, wherein the volatile components then flow out with the gas through the discharge line 6. The bubbling of the gas through the sample liquid 3 facilitates the driving out of the volatile components.

The discharge line 6 is connected fluidically and releasably to a trap element 10. In the embodiment shown, a fluid line 7 is arranged between discharge line 6 and trap element 10. The fluid line 7 further comprises a water trap 10 in which water, located with the gas, or moisture are held back. The releasable connection between the trap element 10 and therefore the discharge line 6 and the trap element is designed as a quick-action coupling 9, for example via a bayonet catch.

The trap element 10 comprises an absorber material 11 and a gas outlet 12. Between the gas canister 13 and the gas outlet 12, a flow of gas can thus be ensured which drives volatile components out of the sample liquid 3 and then entrains these through the discharge line 6, the fluid line 7 and the water trap 8 into the trap element 10, where they are held back in the absorber material 11. The gas is then released from the gas outlet 12 into the atmosphere or, alternatively, is collected in a vessel (not shown) for reuse.

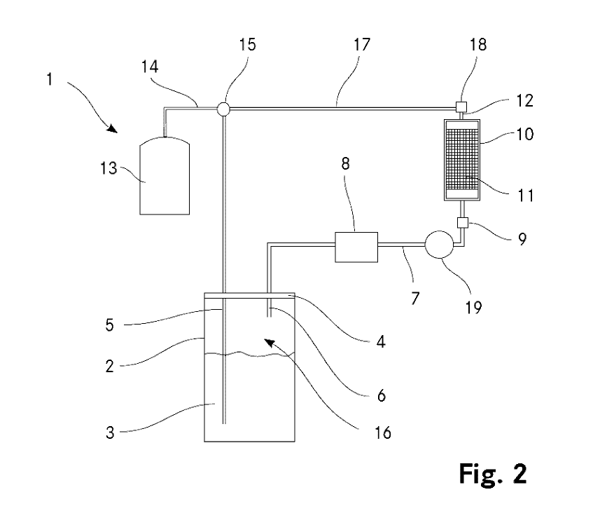

FIG. 2 shows a schematic view of a second embodiment of a device 1 according to the invention. In contrast to the first embodiment according to FIG. 1, the gas outlet 12 is fluidically connected to the supply line 5 via a second fluid line 17 and the gas valve 15. A closed circuit of the gas can be obtained in this way. The gas outlet 12 of the trap element 10 is releasably connected to the supply line 5 via a second quick-action coupling 18. By means of the two quick-action couplings 9, 18, the trap element can thus be quickly and easily released from the device 1, e.g. to be transferred to an analysis apparatus. In order to ensure a continuous flow of gas, the device 1 in this embodiment additionally has a pump 19.

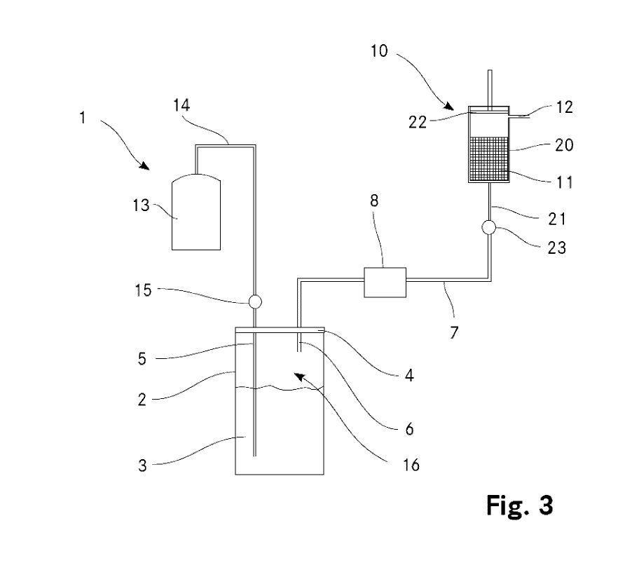

FIG. 3 shows a third embodiment of a device 1 according to the invention. In this embodiment, the trap element 10 is designed as a syringe 20, in the barrel of which the absorption material 11 is arranged. The syringe 20 has a cannula 21, which is plugged into an access opening 23. By way of the cannula 21 and the access opening 23, the syringe 20 can be releasably connected to the discharge line 6. The access opening 23 is preferably designed as a gas-tight closure, preferably as a septum, into which the cannula 21 can be pushed. The access opening 23 is configured in such a way that it is closed in a gas-tight manner when the cannula 21 is not connected thereto. The barrel of the syringe 20 moreover has a gas outlet 12. A piston is moreover arranged in the syringe, with which piston a defined volume can be injected into the analysis apparatus after the connection to the discharge line 6 has been separated and after the syringe 20 has been transferred to an analysis apparatus and after the desorption of the volatile components from the absorber material 11.

1.-9. (canceled)

10. A device for extracting volatile components from a sample, comprising:
a) a sample vessel for receiving the sample with a supply line and with a discharge line, wherein the sample vessel is closed in a gas-tight manner;
b) a gas reservoir which is connected to the supply line;
c) a trap element which is fluidically connected to the discharge line and which has at least one absorber material,
wherein the trap element is connected releasably to the discharge line and the trap element has a gas outlet such that, when the trap element is connected to the discharge line, a gas from the gas reservoir can flow through said trap element.

11. The device according to claim 10, wherein the trap element is fluidically connected to the discharge line in a releasable manner via a quick-action coupling.

12. The device according to claim 10, wherein the trap element has a cannula which is connected releasably to the discharge line via an access opening, and wherein the cannula is in particular plugged into the access opening.

13. The device according to claim 10, wherein the gas outlet is connected fluidically and releasably to the supply line.

14. The device according to claim 10, wherein the trap element is designed as a syringe, and wherein the absorber material is arranged in a barrel of the syringe.

15. The device according to claim 10, wherein the device has a handling element with which the trap element is movable from the discharge line to an injection port of an analysis apparatus.

16. The device according to claim 10, wherein a water trap is arranged between the discharge line and the trap element.

17. The device according to claim 10, wherein the trap element is arranged releasably in a holder, and wherein the holder has a heating and/or a cooling device.

18. A method for extracting volatile components from a sample using a device according to claim 10, said method comprising the following steps:
a) arranging the sample in the sample vessel , wherein the sample vessel is then closed in a gas-tight manner;
b) introducing a gas from a gas reservoir through the supply line into the sample vessel, wherein the gas is conveyed through the discharge line into the trap element connected fluidically and releasably to said discharge line, and flows through said trap element, and wherein the gas then emerges from the trap element through the gas outlet;
wherein the introduction of the gas is interrupted after a predetermined time, the trap element is released from the discharge line and transferred to an analysis apparatus.
